(19) United States
(12) Patent Application Publication
(10) Pub. No.: US 2026/0094608 A1
(43) Pub. Date: Apr. 2, 2026

(54) SYSTEM AND METHOD FOR VIDEO TRANSCRIPT TRANSFORMATION

(71) Applicant: Atlassian US, Inc., San Francisco, CA (US)

(72) Inventors: Jose Manuel Medina, Oakland, CA (US); Zhaoyi Ma, Orlando, FL (US); Matthew Job Granmoe, Inver Grove Heights, MN (US); Sean Goodwin, Arlington, VA (US); Rajiv Sancheti, San Francisco, CA (US); Connor Ryan Waslo, New York, NY (US)

(21) Appl. No.: 19/335,697

(22) Filed: Sep. 22, 2025

Related U.S. Application Data
(60) Provisional application No. 63/700,930, filed on Sep. 30, 2024.

(51) Int. Cl. G10L 15/26

(52) U.S. Cl. CPC G10L 15/26

(57) ABSTRACT

Various embodiments provide a system and method for transforming video content into various document formats or external service outputs. The system includes a video transformation apparatus configured to receive a recorded video object and generate a transcript. A transcript transformation interface is rendered on a client device, allowing user interaction to select transformation options. The system generates transformation prompts based on external service rules and templates, which are processed by a transcript transformation model to produce transformed transcript data objects. These objects are validated and can be customized through further user interactions. The system supports integration with external services by mapping transformed data to external service attributes, enabling direct output to services such as collaborative document platforms, workflow management systems, and communication services. This facilitates the automatic creation of collaborative documents, workflow tasks or sequences, and messages directly from video content, enhancing productivity and integration in various operational environments.

### CROSS-REFERENCE TO RELATED APPLICATIONS

This application claims the benefit of U.S. Provisional Patent Application No. 63/700,930, entitled SYSTEM AND METHOD FOR VIDEO TRANSCRIPT TRANSFORMATION, which was filed Sep. 30, 2024, the entire contents of which are hereby incorporated by reference in its entirety.

### FIELD OF THE INVENTION

The present disclosure relates to video content processing systems, and more particularly to a system and method for transforming video transcripts into various external service defined formats using artificial intelligence.

### BACKGROUND

Video content has become increasingly prevalent in various aspects of personal and professional communication. As the volume of video content grows, Applicant has identified a need to develop efficient ways to extract, process, and repurpose information contained within videos. Transcription services have made it possible to convert spoken content in videos into text, but further processing and transformation of these transcripts into different formats or for specific purposes often requires manual effort. Automated systems for transforming video transcripts could potentially streamline workflows and enhance the utility of video content across different software applications and platforms.

### OVERVIEW

The present disclosure describes systems and methods for transforming video transcripts into various formats tailored for external services using generative artificial intelligence. The disclosed video transformation apparatus receives a recorded video object and generates a transcript of the video recording. A transcript transformation interface is rendered on a client device, allowing users to interact and provide transcript transformation instructions.

Based on these instructions, a transcript transformation model generates a transformed transcript data object. This transcript transformation model may be a generative artificial intelligence model configured to produce text content representing a transformation of the transcript according to user-selected service transformation options. The transformed transcript data object can be formatted as a written document object, an external workflow object, or an external communication object, each designed to render specific types of transformed transcript generated content on the client device. For example and without limitation, the transformed transcript data object can be formatted as: a written data object configured to render a standard operation procedure document or a step-by-step action plan, an external workflow object configured to populate a task or “issue” in Jira Software® by Atlassian, an external communication object configured to render a customized message in Slack® or Microsoft Teams®, or in a manner that is optimized for seamless use and ingestion into one or more other external services.

The system accesses external service rules and templates associated with various external services, such as collaborative document services, workflow services, and communication platforms. These rules and templates are used to generate transcript transformation prompts, which guide the transcript transformation model in creating appropriately formatted and structured output for seamless integration with the target external service.

The transcript transformation interface includes a service transformation options interface, presenting selectable options for different types of transformation operations. This allows users to customize the transformation process based on their specific needs and the requirements of the target external service.

The apparatus can also handle updated transcript transformation instructions, generating updated transformed transcript data objects as users refine their preferences or requirements. Additionally, the system can receive external service output instructions and output the transformed transcript data object directly to an external service, facilitating efficient integration with various software platforms and workflows.

By automating the process of transforming video transcripts into various formats suitable for different external services, the disclosed system addresses the need for efficient processing and repurposing of video content, streamlining workflows and enhancing the utility of video communications across diverse software applications and platforms.

### BRIEF DESCRIPTION OF FIGURES

FIG. 1 illustrates a system diagram of a video transformation system, according to aspects of the present disclosure.

FIG. 2 illustrates a block diagram of a transcript transformation service, according to an embodiment.

FIG. 3 illustrates a block diagram of a video management interface for managing and transforming recorded video content, according to aspects of the present disclosure.

FIG. 4A illustrates a transcript transformation interface for displaying transformed transcript generated content, according to an embodiment.

FIG. 4B illustrates the transcript transformation interface of FIG. 4A with different transformation options selected, according to aspects of the present disclosure.

FIG. 5 illustrates a transcript transformation interface for generating and customizing transformed transcript content, according to an embodiment.

FIG. 6 illustrates another transcript transformation interface for generating and customizing transformed transcript content, according to aspects of the present disclosure.

FIG. 7 illustrates a sequence diagram of interactions between components of the video transformation system, according to an embodiment.

### DETAILED DESCRIPTION

The present disclosure relates to systems and methods for transforming video transcripts into various formats suitable for different external services using generative artificial intelligence. These systems and methods provide an efficient way to extract, process, and repurpose information contained within videos. The disclosed video transformation apparatus receives a recorded video object and generates a transcript of the video recording. A transcript transformation interface is rendered on a client device, allowing users to interact and provide transcript transformation instructions.

Based on these instructions, a transcript transformation model generates a transformed transcript data object. This model may be a generative artificial intelligence model configured to produce content representing a transformation of the transcript according to user-selected service transformation options. The transformed transcript data object can be formatted as a written document object, an external workflow object, or an external communication object, each designed to render specific types of transformed transcript generated content on the client device.

The system accesses external service rules and templates associated with various external services, such as collaborative document services, workflow services, and communication platforms. These rules and templates are used to generate transcript transformation prompts, which guide the transcript transformation model in creating appropriately formatted and structured output for seamless integration with the target external service. By automating the process of transforming video transcripts into various formats suitable for different external services, the disclosed system addresses the need for efficient processing and repurposing of video content, streamlining workflows and enhancing the utility of video communications across diverse software applications and platforms.

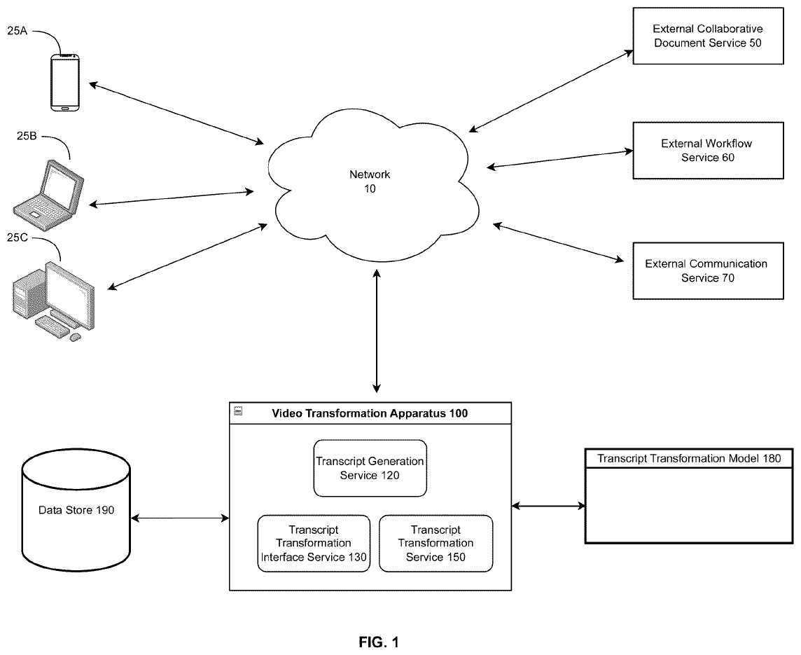

Referring to FIG. 1, the figure illustrates a system diagram of a video transformation system. The system includes a network 10 that connects various components and services. Connected to the network 10 are client devices including a mobile device 25A, a laptop computer 25B, and a desktop computer 25C. These client devices can interact with the video transformation system through the network 10.

In various embodiments, each external service, including an external collaborative document service 50, an external workflow service 60, and an external communication service 70, is separate and distinct from one another and from the video transformation apparatus 100. This means that each of these services operates based on separate compiled code bases, engages in communications through separate secure firewalls, and may have different user interfaces and functionalities. Each of the depicted external services provides rules and templates that are used by the video transformation apparatus 100 as discussed in detail below.

The network 10 may be any type of network capable of transmitting data, such as a local area network (LAN), a wide area network (WAN), a cellular network, or the internet. The network 10 manages communications among various services in a cloud-based software platform, allowing for real-time or near real-time data exchange and processing.

At the core of the system is the video transformation apparatus 100, which contains several components: a transcript generation service 120, a transcript transformation interface service 130, and a transcript transformation service 150. These components work together to process and transform video content.

The transcript generation service 120 generates transcripts from recorded video objects. This involves converting the audio content of the video into text, which can then be processed and transformed by the other components of the video transformation apparatus 100.

In some aspects, the transcript generation service 120 may utilize an instantaneous transcription process to generate the transcript in real-time as the video is being recorded or played back. This process may involve breaking the audio stream into short segments, typically lasting a few seconds each. These segments are then processed through a speech recognition model that converts the audio into text. In some embodiments, the process may involve detecting the language spoken in the video recording and processing the audio segments through a speech recognition model that is configured for such spoken language.

The model may use techniques such as acoustic modeling and language modeling to accurately transcribe the speech. As each segment is transcribed, it is immediately added to the growing transcript. This approach allows for low-latency transcription, enabling near real-time availability of the transcript for editing purposes. The instantaneous transcription process may also incorporate speaker diarization to distinguish between different speakers in the video, further enhancing the usefulness of the transcript for editing tasks. An example instantaneous transcription process is disclosed in commonly owned U.S. patent application Ser. No. 18/759,644 entitled “Instantaneous Media Stream Transcription Systems and Methods”, which was filed Jun. 28, 2024 and is hereby incorporated by reference in its entirety.

The transcript transformation interface service 130 causes various user interfaces to be rendered on the client device and communicates with a client-side software application to ensure associated user inputs are received based on user engagement with such user interfaces. This allows users to interact with the system and provide instructions for how they want the video transcript to be transformed.

The transcript transformation service 150 generates prompts based on user-selected transcript transformation options and manages transmission of such prompts to the transcript transformation model 180. This model is a generative artificial intelligence model that generates content representing a transformation of the transcript according to the prompts.

Connected to the video transformation apparatus 100 is a data store 190, which is configured to store video data (e.g., recorded video objects), transcripts, transformed transcript data objects, external service transformed transcript data objects, and other relevant information. This allows the system to maintain a record of the processed and transformed video content, which can be accessed and used in future operations.

The system also includes a transcript transformation model 180, which is a generative artificial intelligence model that is connected to the video transformation apparatus 100 and is configured to generate content that represents a transformation of transcripts based specifically determined prompts that are based on user-selected service transformation options and other user configurations. A few example generative artificial intelligence models that may be used in association with embodiments of the invention are GPT-3.5, GPT-4 (+ function calling), and GPT-40-mini by OpenAI.

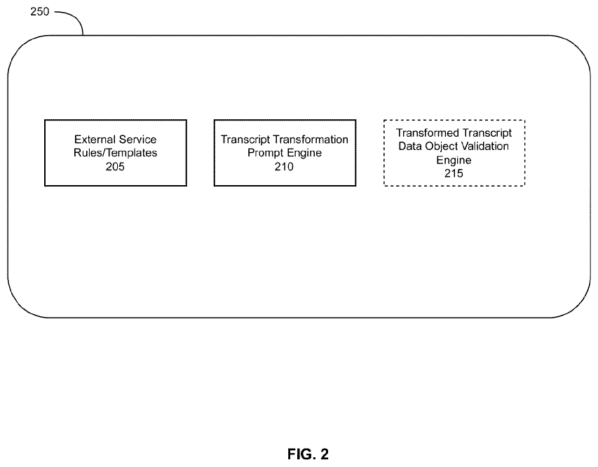

Referring to FIG. 2, the figure illustrates a block diagram of a transcript transformation service 250. The transcript transformation service 250 includes an external service rules/templates module 205, a transcript transformation prompt engine 210, and a transformed transcript data object validation engine 215. These components work together to process and transform transcripts for external services.

The external service rules/templates module 205 is configured to access rules and templates associated with various external services. These rules and templates provide guidelines for how the transcript should be transformed to be compatible with the respective external service. The rules and templates may be stored locally within the transcript transformation service 250 or may be retrieved from the external service through an application program interface or other similar means. In some cases, the external service rules/templates module 205 may also support a dedicated user interface for users to customize the rules and templates based on their specific needs or those of one or more external services.

The transcript transformation prompt engine 210 generates transcript transformation prompts based on the rules and templates provided by the external service rules/templates module 205 and also from the content (e.g., text, timestamps, metadata, etc.) of a selected transcript. These prompts guide the transformation of the transcript by the transcript transformation model and are tailored to the specific requirements of the target external service. The prompts may include instructions for formatting, structuring, annotating, summarizing, or rephrasing the transcript, among other things. The prompts may be accompanied by additional text, data, video file data, user name, generative model output language instructions, and the like depending upon the particular use case and on the requirements of any related external service. For example, transcript transformation prompts that are configured to generate external workflow transformed transcript generated content (e.g., Jira tickets) may include title, description, video file object, an output language identifier (e.g., English, Spanish, etc.) and custom metadata that is configured to cause the receiving transcript transformation model to output generated content in a form and language that is ingestible by an external workflow service.

The transformed transcript data object validation engine 215 optionally verifies the transformed transcript data objects generated by the transcript transformation service 250. This transformed transcript data object validation engine 215 checks the transformed transcript data objects for errors, inconsistencies, or deviations from the rules and templates provided by the external service rules/templates module 205. If any issues are detected, the transformed transcript data object validation engine 215 may flag the issues for review by a user or automatically correct them, depending on the nature of the issue.

In operation, the transcript transformation service 250 receives a transcript from the transcript generation service 120 (as shown in FIG. 1). The external service rules/templates module 205 retrieves the appropriate rules and templates for the target external service. The transcript transformation prompt engine 210 then generates prompts based on these rules and templates, and the transcript is transformed by the transcript transformation model according to these prompts. The transformed transcript data object validation engine 215 then verifies the transformed transcript data object before it is output to the target external service. This process ensures that the transformed transcript is compatible with the target external service and meets the user's specific needs.

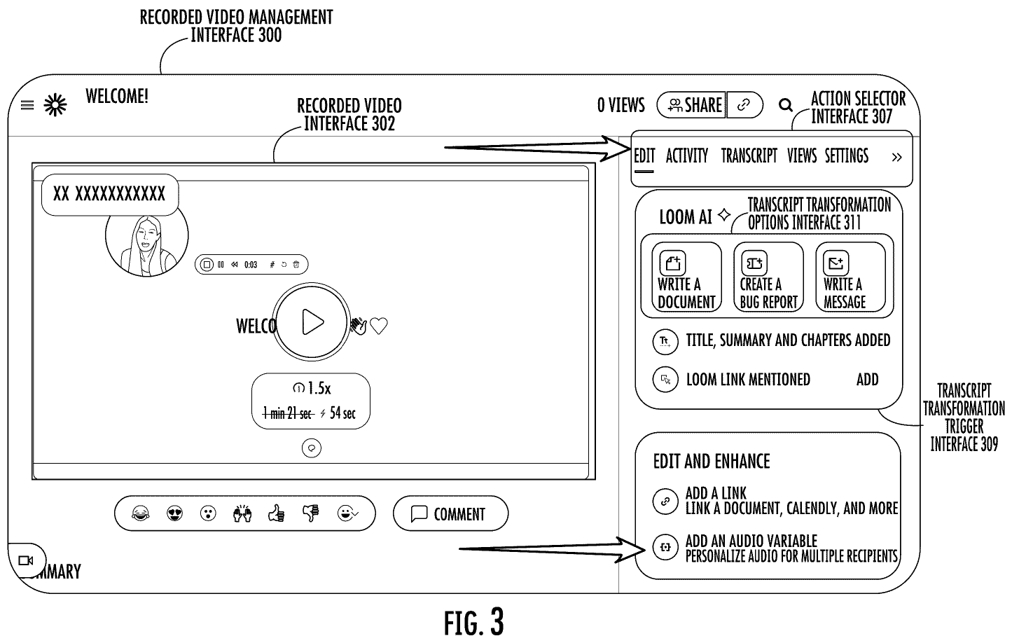

Referring to FIG. 3, the figure illustrates a video management interface 300 that allows users to interact with recorded video content and access various transcript transformation options. The video management interface 300 is a user interface rendered on a client device, such as a mobile device 25A, a laptop computer 25B, or a desktop computer 25C (as shown in FIG. 1). The interface 300 provides a user-friendly environment for managing, editing, and transforming video content.

The video management interface 300 includes a recorded video interface 302, which displays the video content. The recorded video interface 302 may include a video player with playback controls, allowing users to play, pause, rewind, or fast-forward the video. In some cases, the recorded video interface 302 may also provide options for adjusting the video quality, enabling subtitles, or changing the playback speed.

Adjacent to the recorded video interface 302 is an action selector interface 307. The action selector interface 307 provides various tabs for different actions that a user can perform on the video. These actions may include editing the video, viewing activity related to the video, accessing the video transcript, viewing the number of views the video has received, and adjusting the video settings. The action selector interface 307 allows users to easily navigate between different functionalities of the video management interface 300.

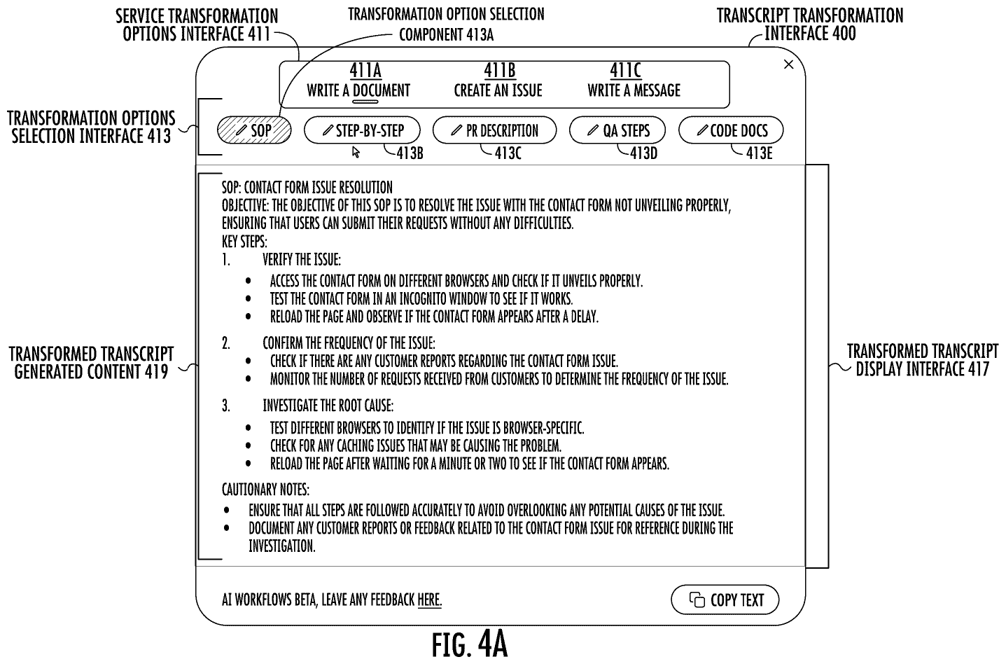

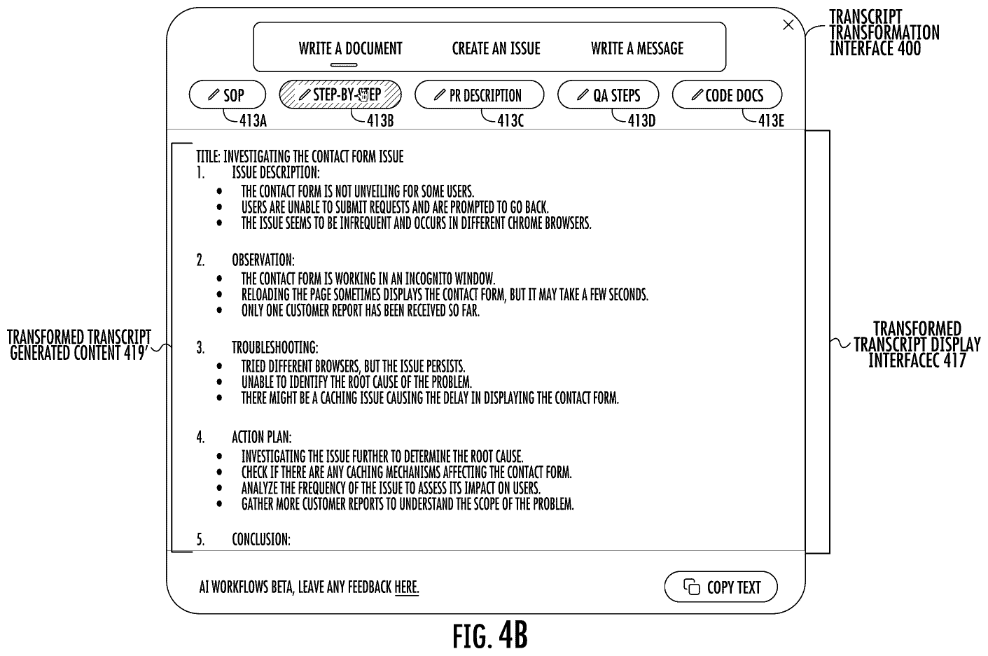

Below the action selector interface 307 is a transcript transformation trigger interface 309. The transcript transformation trigger interface 309 is a user interface component that allows users to initiate the process of transforming the video transcript. When a user engages with the transcript transformation trigger interface 309, a transcript transformation interface (as shown in FIGS. 4A and 4B) is rendered on the client device, allowing the user to select transformation options and view the resulting transformed content.

The video management interface 300 also includes a transcript transformation options interface 311. The transcript transformation options interface 311 presents various options for transforming the video transcript. In the depicted embodiment, these options include generating a written document, creating a bug report, or writing a message. Each of these options corresponds to a different transformation operation that can be performed on the video transcript. By selecting one of these options, the user can specify how they want the video transcript to be transformed.

In some aspects, the video management interface 300 may also include additional features for editing and enhancing the video. These features may include options for adding links to the video, inserting audio variables, or applying other types of edits or enhancements. These features provide users with a comprehensive set of tools for managing and transforming their video content.

In summary, the video management interface 300 provides a user-friendly environment for managing, editing, and transforming video content. By providing various options for transforming the video transcript and integrating these options into a single, easy-to-use interface, the video management interface 300 enhances the utility of video content and streamlines the process of repurposing video content for different external services.

Referring to FIG. 4A, the figure illustrates a transcript transformation interface 400 that allows users to select transformation options and view the resulting transformed content. The transcript transformation interface 400 includes a service transformation options interface 411 at the top, which presents three options for users: “Write a document” 411A, “Create an issue” 411B, and “Write a message” 411C. These options allow users to select different transformation operations based on their specific needs or the requirements of the target external service.

Below the service transformation options interface 411 is the transformation options selection interface 413. This interface contains transformation option selection components 413A-E, which include “SOP” for a standard operating procedure type document, “Step-by-step” for a step-by-step instructions type document, “PR description” for a “pull request” description for a software development document, “QA steps” for a questions and answers formatted document, and “Code docs” for a software source code document. These components allow users to choose specific document types that govern automated transformation of the transcript.

In some aspects, the transformation options selection interface 413 may include additional transformation option selection components for other types of documents or external service objects. For example, the transformation options selection interface 413 may include transformation option selection components for generating a software bug report, a project management task, a customer support ticket, or a social media post, among others. The transformation options selection interface 413 may also include transformation option selection components for generating transformed transcript content in formats such as plain text, rich text, and HTML. However, in other embodiments, transformed transcript content may be generated in other suitable formats.

The transformed transcript display interface 417 is configured to display the transformed transcript generated content 419. In the example shown, the content is an SOP (Standard Operating Procedure) for Contact Form Issue Resolution. The SOP includes an objective, key steps, and cautionary notes related to resolving issues with a contact form not unveiling properly. The transformed transcript generated content 419 is generated by the transcript transformation model based on the transcript of the recorded video object and on the selected transformation option selection component.

In some cases, the transformed transcript display interface 417 may also provide editing tools that allow users to modify the transformed transcript generated content 419. For example, the transformed transcript display interface 417 may provide text editing tools, formatting tools, annotation tools, or other suitable tools for modifying the transformed transcript generated content 419. This allows users to further customize the transformed transcript generated content 419 to meet their specific needs or the requirements of the target external service.

In summary, the transcript transformation interface 400 provides a user-friendly environment for selecting transformation options and viewing the resulting transformed content. By integrating the selection of transformation options and the display of transformed content into a single interface, the transcript transformation interface 400 streamlines the process of transforming video transcripts and enhances the utility of video content.

Referring to FIG. 4B, the figure illustrates an updated version of the transcript transformation interface 400. In this embodiment, the user has selected the “Step-by-step” transformation option selection component 413B from the transformation options selection interface 413. This selection indicates that the user wants the transcript to be transformed into a step-by-step guide.

Upon selection of the “Step-by-step” transformation option selection component 413B, the transcript transformation prompt engine 210 (as shown in FIG. 2) generates a new prompt based on the rules and templates associated with step-by-step guides. This prompt is then used by the transcript transformation model 180 (as shown in FIG. 1) to generate new transformed transcript generated content 419.

The transformed transcript display interface 417 displays the updated transformed transcript generated content 419, which now takes the form of a step-by-step guide. This guide provides a detailed, step-by-step explanation of how to investigate a contact form issue, based on the content of the video transcript. The guide includes an introduction, a list of required tools, and a series of steps to follow. Each step is clearly numbered and includes a detailed description of the action to be taken.

In some cases, the transformed transcript generated content 419 may also include additional information, such as tips, warnings, or notes, to provide further guidance to the user. This additional information may be generated by the transcript transformation model 180 based on the content of the video transcript and the rules and templates associated with step-by-step guides.

The updated transcript transformation interface 400 allows users to easily transform their video transcripts into a variety of formats suitable for different external services. By providing a user-friendly interface for selecting transformation options and viewing the resulting transformed content, the transcript transformation interface 400 enhances the utility of video content and streamlines the process of repurposing video content for different external services.

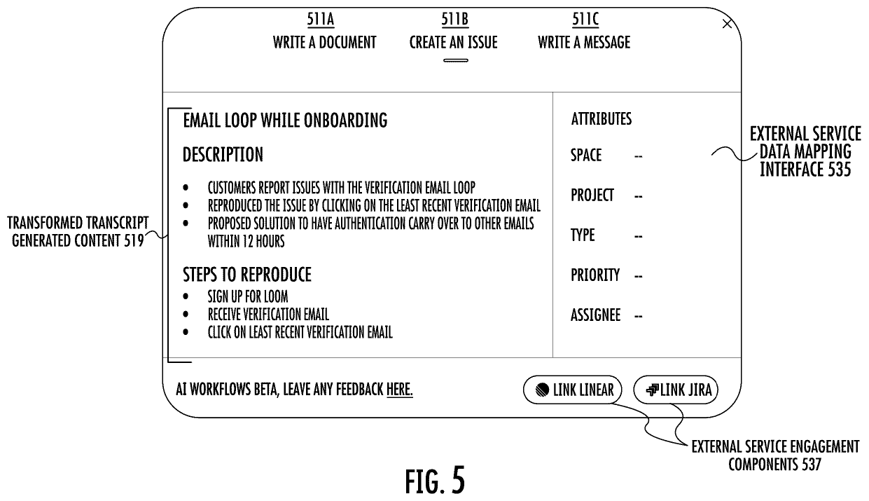

FIG. 5 depicts a transcript transformation interface configured to generate and customize transformed transcript content for an external workflow service. The interface includes three main options at the top: collaborative document transformation option selection component 511A, external workflow service transformation option selection component 511B, and external communication service transformation option selection component 511C. The external workflow service transformation option selection component 511B is highlighted, indicating it is currently selected.

Upon selection of the external workflow service transformation option selection component 511B, the transcript transformation prompt engine 210 (as shown in FIG. 2) generates a new prompt based on the rules and templates associated with the external workflow service. This prompt is then used by the transcript transformation model 180 (as shown in FIG. 1) to generate transformed transcript generated content 519.

The transformed transcript generated content 519 is displayed in the transformed transcript display interface (shown in FIGS. 4A-B) but not separately called out in FIG. 5. In the depicted example, the content includes a description of a software bug and steps to reproduce it, which were generated based on a video recording of software development operations team members discussing this issue.

To the right of the transformed transcript generated content 519 is an external service data mapping interface 535. This external service data mapping interface 535 contains fields for receiving entry of external service attributes or data elements such as Space, Project, Type, Priority, and Assignee. In some examples, such external service attributes may be appended to the transformed transcript generated content to form the transformed transcript generated object. Such transformed transcript generated objects are configured for seamless ingestion by one or more external workflow services such as Jira Software® by Atlassian in the depicted example.

At the bottom of the interface are external service engagement components 537, represented by two buttons labeled “Link Linear” and “Link Jira”. These components allow users to connect the transformed transcript generated object with two different external workflow management services (e.g., Linear and Jira Software). In some embodiments, the external service engagement components 537 launch external service portals or embedded external service functionality that allows user engagement with native functionality of the external workflow services. In some embodiments, such external portals may require execution of an access authentication process before native functionality of related external workflow services is enabled.

In some aspects, the transcript transformation interface may also provide editing tools that allow users to modify the transformed transcript generated content 519. For example, the transformed transcript display interface may provide text editing tools, formatting tools, annotation tools, or other suitable tools for modifying the transformed transcript generated content 519. This allows users to further customize the transformed transcript generated content 519 to meet their specific needs or the requirements of the target external service.

In summary, the transcript transformation interface shown in FIG. 5 provides a user-friendly environment for selecting transformation options and viewing the resulting transformed content. By integrating the selection of transformation options and the display of transformed content into a single interface, the transcript transformation interface streamlines the process of transforming video transcripts and enhances the utility of video content.

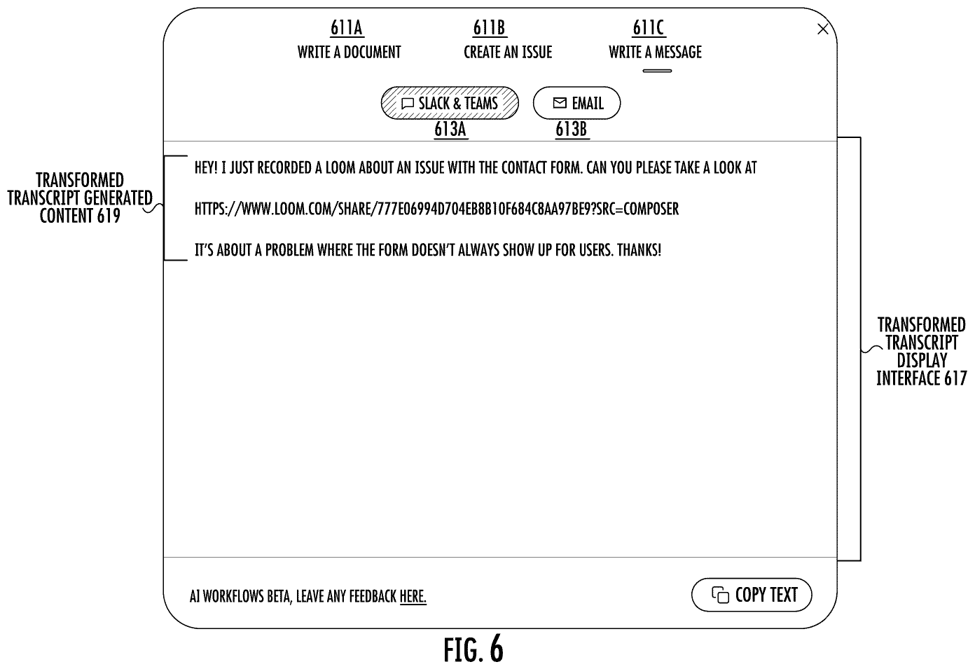

Referring to FIG. 6, the figure illustrates a transcript transformation interface configured to generate and customize transformed transcript content for an external communication service. The interface includes three main options at the top: document option 611A, issue option 611B, and message option 611C. The message option 611C is highlighted, indicating it is currently selected.

Upon selection of the message option 611C, the transcript transformation prompt engine 210 (as shown in FIG. 2) generates a new prompt based on the rules and templates associated with the external communication service. This prompt is then used by the transcript transformation model 180 (as shown in FIG. 1) to generate transformed transcript generated content 619.

Below these options are two transformation selection components: chat selection 613A labeled “Slack & Teams” and email selection 613B labeled “Email”. The chat selection 613A is highlighted, suggesting it is the active selection. This selection indicates that the user wants the transcript to be transformed into a chat message suitable for sharing on platforms such as Slack® or Microsoft Teams®.

The transformed transcript interface 617 displays the transformed transcript content 619. This content includes a message about a recorded video discussing an issue with a contact form. The message provides a link to the video and briefly describes the problem, stating that the form doesn't always show up for users. This message is generated based on the content of the video transcript and the rules and templates associated with chat messages.

In some aspects, the transformed transcript interface 617 may also provide editing tools that allow users to modify the transformed transcript content 619. For example, the transformed transcript interface 617 may provide text editing tools, formatting tools, annotation tools, or other suitable tools for modifying the transformed transcript content 619. This allows users to further customize the transformed transcript content 619 to meet their specific needs or the requirements of the target external communication service.

In summary, the transcript transformation interface shown in FIG. 6 provides a user-friendly environment for selecting transformation options and viewing the resulting transformed content. By integrating the selection of transformation options and the display of transformed content into a single interface, the transcript transformation interface streamlines the process of transforming video transcripts and enhances the utility of video content.

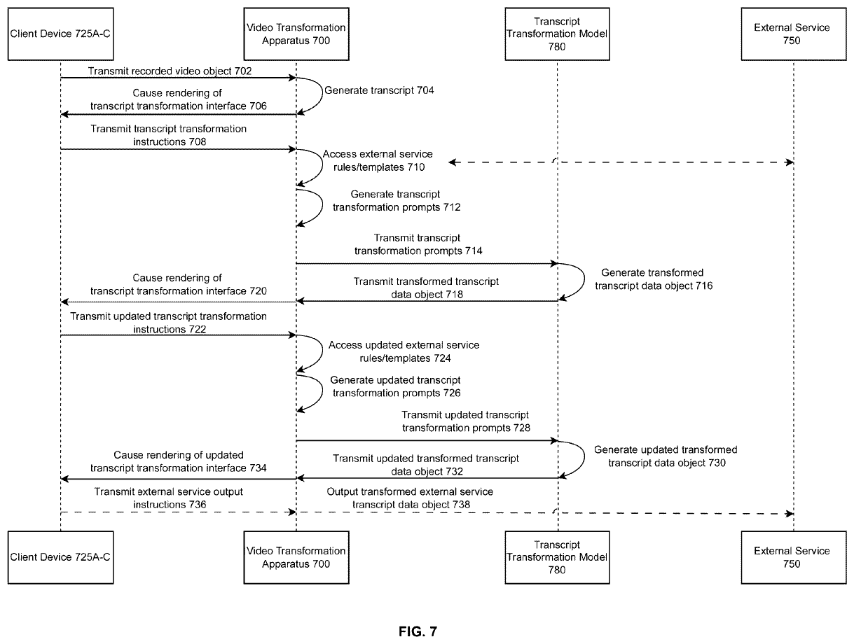

FIG. 7 depicts a sequence of interactions between a client device 725A-C, a video transformation apparatus 700, a transcript transformation model 780, and an external service 750. The sequence diagram highlights the selected steps in the transcript transformation process.

The process begins with the client device 725A-C transmitting a recorded video object to the video transformation apparatus 700 in step 702. The video transformation apparatus 700, specifically the transcript generation service 120 (as shown in FIG. 1), generates a transcript of the video recording in step 704. The transcript transformation interface service 130 (as shown in FIG. 1) then causes the rendering of a transcript transformation interface on the client device 725A-C in step 706. This transcript transformation interface allows users to interact with the system and provide transcript transformation instructions.

In response to user engagement with the transcript transformation interface, the client device 725A-C transmits transcript transformation instructions to the video transformation apparatus 700 in step 708. Upon receiving these instructions, the transcript transformation service 150 (as shown in FIG. 1) of the video transformation apparatus 700 accesses external service rules/templates from the external service rules/templates module 205 (as shown in FIG. 2) in step 710. These rules/templates are used to generate transcript transformation prompts in step 712 by the transcript transformation prompt engine 210 (as shown in FIG. 2).

The transcript transformation prompts are then transmitted to the transcript transformation model 780 in step 714. The transcript transformation model 780, which may be a generative artificial intelligence model, generates a transformed transcript data object in step 716. This transformed transcript data object is then sent back to the video transformation apparatus 700 in step 718.

Upon receiving the transformed transcript data object, the video transformation apparatus 700 causes the rendering of the transcript transformation interface on the client device 725A-C in step 720. The client device 725A-C then transmits updated transcript transformation instructions to the video transformation apparatus 700 in step 722 based on new user engagement with the transcript transformation interface.

In response to receiving the updated transcript transformation instructions, the video transformation apparatus 700 accesses updated external service rules/templates in step 724 and generates updated transcript transformation prompts in step 726. These updated prompts are transmitted to the transcript transformation model 780 in step 728, which generates an updated transformed transcript data object in step 730. This updated transformed transcript data object is sent back to the video transformation apparatus 700 in step 732.

Finally, the video transformation apparatus 700 causes the rendering of an updated transcript transformation interface on the client device 725A-C in step 734. Optionally, the client device 725A-C transmits external service output instructions to the video transformation apparatus 700 in step 736. In response to these instructions, the video transformation apparatus 700 outputs the transformed external service transcript data object to the external service 750 in step 738.

In some aspects, the transformed external service transcript data object is configured based on rules/templates of the receiving external service and thereby is seamlessly ingested. This sequence of interactions and operations enables the efficient transformation of video transcripts into various formats suitable for different external services.

The terms “client device”, “computing device”, “user device”, and the like may be used interchangeably to refer to computer hardware that is configured (either physically or by the execution of software) to access one or more of an application, service, or repository made available by a server (e.g., apparatus of the present disclosure) and, among various other functions, is configured to directly, or indirectly, transmit and receive data. The server is often (but not always) on another computer system, in which case the client device accesses the service by way of a network. Example client devices include, without limitation, smart phones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure.

The terms “data,” “content,” “digital content,” “digital content object,” “signal,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use computer-readable storage medium, other types of computer-readable mediums can be substituted for or used in addition to the computer-readable storage medium in alternative embodiments.

The terms “application,” “software application,” “app,” “product,” “service” or other similar terms refer to a computer program or group of computer programs designed to perform coordinated functions, tasks, or activities for the benefit of a user or group of users. A software application can run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “machine learning module,” “machine learning model,” “ML model(s)”, or “artificial intelligence model(s)” refer to a machine learning or deep learning task or algorithm. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders), speech-to-text models, or generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or VQGAN models).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” “in one aspect”, and the like generally mean that the particular feature, structure, or characteristic following the phrase may be included in the at least one embodiment of the present invention and may be included in more than one embodiment of the present invention (importantly, such phrases do not necessarily refer to the same embodiment).

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive a recorded video object that is configured to cause playback, on a client device, of a video recording of at least one speaker; generate a transcript of the video recording based on the recorded video object; cause rendering of a transcript transformation interface to a display of the client device; receive transcript transformation instructions following user interaction with the transcript transformation interface; cause generation, by a transcript transformation model, of a transformed transcript data object based on the transcript transformation instructions; and output the transformed transcript data object to the client device.

Clause 2. The apparatus of Clause 1, wherein the transformed transcript data object is formatted by the transcript transformation model as a written document object and is configured to cause rendering of a written document transformed transcript generated content to the display of the client device.

Clause 3. The apparatus of any of the aforementioned Clauses, wherein the transformed transcript data object is formatted by the transcript transformation model as an external workflow object and is configured to cause rendering of an external workflow transformed transcript generated content interface to the display of the client device.

Clause 4. The apparatus of any of the aforementioned Clauses, wherein the transformed transcript data object is formatted by the transcript transformation model as an external communication object and is configured to cause rendering of an external communication transformed transcript generated content interface to the display of the client device.

Clause 5. The apparatus of any of the aforementioned Clauses, wherein the instructions are further operable to cause the apparatus to: access external service rules and templates associated with an external service; and generate transcript transformation prompts based on the external service rules and templates, wherein the transcript transformation model generates the transformed transcript data object based on the transcript transformation prompts.

Clause 6. The apparatus of any of the aforementioned Clauses, wherein the transcript transformation interface comprises a service transformation options interface that includes selectable options for different types of transformation operations.

Clause 7. The apparatus of any of the aforementioned Clauses, wherein the instructions are further operable to cause the apparatus to: receive updated transcript transformation instructions based on user interaction with the transcript transformation interface; and cause generation, by the transcript transformation model, of an updated transformed transcript data object based on the updated transcript transformation instructions.

Clause 8. The apparatus of any of the aforementioned Clauses, wherein the instructions are further operable to cause the apparatus to: receive external service output instructions; and output the transformed transcript data object to an external service based on the external service output instructions.

Clause 9. The apparatus of any of the aforementioned Clauses, wherein the transcript transformation model comprises a generative artificial intelligence model configured to generate content that represents a transformation of the transcript based on user-selected service transformation options.

Clause 10. A method comprising: receiving a recorded video object configured to cause playback, on a client device, of a video recording of at least one speaker; generating a transcript of the video recording based on the recorded video object; causing rendering of a transcript transformation interface to a display of the client device; receiving transcript transformation instructions following user interaction with the transcript transformation interface; generating, by a transcript transformation model, a transformed transcript data object based on the transcript transformation instructions; and outputting the transformed transcript data object to the client device.

Clause 11. The method of Clause 10, wherein the transformed transcript data object is formatted by the transcript transformation model as a written document object and is configured to cause rendering of a written document transformed transcript generated content to the display of the client device.

Clause 12. The method of any of Clauses 10-11, wherein the transformed transcript data object is formatted by the transcript transformation model as an external workflow object and is configured to cause rendering of an external workflow transformed transcript generated content interface to the display of the client device.

Clause 13. The method of any of Clauses 10-12, wherein the transformed transcript data object is formatted by the transcript transformation model as an external communication object and is configured to cause rendering of an external communication transformed transcript generated content interface to the display of the client device.

Clause 14. The method of any of Clauses 10-13, further comprising: accessing external service rules and templates associated with an external service; and generating transcript transformation prompts based on the external service rules and templates, wherein the transcript transformation model generates the transformed transcript data object based on the transcript transformation prompts.

Clause 15. The method of any of Clauses 10-14, wherein the transcript transformation interface comprises a service transformation options interface that includes selectable options for different types of transformation operations.

Clause 16. The method of any of Clauses 10-15, further comprising: receiving updated transcript transformation instructions based on user interaction with the transcript transformation interface; and generating, by the transcript transformation model, an updated transformed transcript data object based on the updated transcript transformation instructions.

Clause 17. The method of any of Clauses 10-16, further comprising: receiving external service output instructions; and outputting the transformed transcript data object to an external service based on the external service output instructions.

Clause 18. The method of any of Clauses 10-17, wherein the transcript transformation model comprises a generative artificial intelligence model configured to generate content that represents a transformation of the transcript based on user-selected service transformation options.

Clause 19. A non-transitory computer-readable medium storing instructions that, when executed by at least one processor, cause an apparatus to: receive a recorded video object configured to cause playback, on a client device, of a video recording of at least one speaker; generate a transcript of the video recording based on the recorded video object; cause rendering of a transcript transformation interface to a display of the client device; receive transcript transformation instructions following user interaction with the transcript transformation interface; cause generation, by a transcript transformation model, of a transformed transcript data object based on the transcript transformation instructions; and output the transformed transcript data object to the client device.

Clause 20. The non-transitory computer-readable medium of Clause 19, wherein the transformed transcript data object is formatted by the transcript transformation model as a written document object and is configured to cause rendering of a written document transformed transcript generated content to the display of the client device.

Clause 21. The non-transitory computer-readable medium of any of Clauses 19-20, wherein the transformed transcript data object is formatted by the transcript transformation model as an external workflow object and is configured to cause rendering of an external workflow transformed transcript generated content interface to the display of the client device.

Clause 22. The non-transitory computer-readable medium of any of Clauses 19-21, wherein the transformed transcript data object is formatted by the transcript transformation model as an external communication object and is configured to cause rendering of an external communication transformed transcript generated content interface to the display of the client device.

Clause 23. The non-transitory computer-readable medium of any of Clauses 19-22, wherein the instructions further cause the apparatus to: access external service rules and templates associated with an external service; and generate transcript transformation prompts based on the external service rules and templates, wherein the transcript transformation model generates the transformed transcript data object based on the transcript transformation prompts.

Clause 24. The non-transitory computer-readable medium of any of Clauses 19-23, wherein the transcript transformation interface comprises a service transformation options interface that includes selectable options for different types of transformation operations.

Clause 25. The non-transitory computer-readable medium of any of Clauses 19-24, wherein the instructions further cause the apparatus to: receive updated transcript transformation instructions based on user interaction with the transcript transformation interface; and cause generation, by the transcript transformation model, of an updated transformed transcript data object based on the updated transcript transformation instructions.

Clause 26. The non-transitory computer-readable medium of any of Clauses 19-25, wherein the instructions further cause the apparatus to: receive external service output instructions; and output the transformed transcript data object to an external service based on the external service output instructions.

Clause 27. The non-transitory computer-readable medium of any of Clauses 19-26, wherein the transcript transformation model comprises a generative artificial intelligence model configured to generate content that represents a transformation of the transcript based on user-selected service transformation options.

1. A video transformation apparatus comprising at least one processor and a memory storing instructions that are operable, when executed by the processor, to cause the apparatus to:
receive a recorded video object that is configured to cause playback, on a client device, of a video recording of at least one speaker;
generate a transcript of the video recording based on the recorded video object;
cause rendering of a transcript transformation interface to a display of the client device;
receive transcript transformation instructions following user interaction with the transcript transformation interface;
cause generation, by a transcript transformation model, of a transformed transcript data object based on the transcript transformation instructions; and
output the transformed transcript data object to the client device.

2. The video transformation apparatus of claim 1, wherein the transformed transcript data object is formatted by the transcript transformation model as a written document object and is configured to cause rendering of a written document transformed transcript generated content to the display of the client device.

3. The video transformation apparatus of claim 1, wherein the transformed transcript data object is formatted by the transcript transformation model as an external workflow object and is configured to cause rendering of an external workflow transformed transcript generated content interface to the display of the client device.

4. The video transformation apparatus of claim 1, wherein the transformed transcript data object is formatted by the transcript transformation model as an external communication object and is configured to cause rendering of an external communication transformed transcript generated content interface to the display of the client device.

5. The video transformation apparatus of claim 1, wherein the instructions are further operable to cause the apparatus to:
access external service rules and templates associated with an external service; and
generate transcript transformation prompts based on the external service rules and templates, wherein the transcript transformation model generates the transformed transcript data object based on the transcript transformation prompts.

6. The video transformation apparatus of claim 1, wherein the transcript transformation interface comprises a service transformation options interface that includes selectable options for different types of transformation operations.

7. The video transformation apparatus of claim 1, wherein the instructions are further operable to cause the apparatus to:
receive updated transcript transformation instructions based on user interaction with the transcript transformation interface; and
cause generation, by the transcript transformation model, of an updated transformed transcript data object based on the updated transcript transformation instructions.

8. The video transformation apparatus of claim 1, wherein the instructions are further operable to cause the apparatus to:
receive external service output instructions; and
output the transformed transcript data object to an external service based on the external service output instructions.

9. The video transformation apparatus of claim 1, wherein the transcript transformation model comprises a generative artificial intelligence model configured to generate content that represents a transformation of the transcript based on user-selected service transformation options.

10. A method for transforming video content, the method comprising:
receiving a recorded video object configured to cause playback, on a client device, of a video recording of at least one speaker;
generating a transcript of the video recording based on the recorded video object;
causing rendering of a transcript transformation interface to a display of the client device;
receiving transcript transformation instructions following user interaction with the transcript transformation interface;
generating, by a transcript transformation model, a transformed transcript data object based on the transcript transformation instructions; and
outputting the transformed transcript data object to the client device.

11. The method of claim 10, wherein the transformed transcript data object is formatted by the transcript transformation model as a written document object and is configured to cause rendering of a written document transformed transcript generated content to the display of the client device.

12. The method of claim 10, wherein the transformed transcript data object is formatted by the transcript transformation model as an external workflow object and is configured to cause rendering of an external workflow transformed transcript generated content interface to the display of the client device.

13. The method of claim 10, wherein the transformed transcript data object is formatted by the transcript transformation model as an external communication object and is configured to cause rendering of an external communication transformed transcript generated content interface to the display of the client device.

14. The method of claim 10, further comprising:
accessing external service rules and templates associated with an external service; and
generating transcript transformation prompts based on the external service rules and templates, wherein the transcript transformation model generates the transformed transcript data object based on the transcript transformation prompts.

15. The method of claim 10, wherein the transcript transformation interface comprises a service transformation options interface that includes selectable options for different types of transformation operations.

16. The method of claim 10, further comprising:
receiving updated transcript transformation instructions based on user interaction with the transcript transformation interface; and
generating, by the transcript transformation model, an updated transformed transcript data object based on the updated transcript transformation instructions.

17. The method of claim 10, further comprising:
receiving external service output instructions; and
outputting the transformed transcript data object to an external service based on the external service output instructions.

18. The method of claim 10, wherein the transcript transformation model comprises a generative artificial intelligence model configured to generate content that represents a transformation of the transcript based on user-selected service transformation options.

19. A non-transitory computer-readable medium storing instructions that, when executed by at least one processor, cause a video transformation apparatus to:
receive a recorded video object configured to cause playback, on a client device, of a video recording of at least one speaker;
generate a transcript of the video recording based on the recorded video object;
cause rendering of a transcript transformation interface to a display of the client device;
receive transcript transformation instructions following user interaction with the transcript transformation interface;
cause generation, by a transcript transformation model, of a transformed transcript data object based on the transcript transformation instructions; and
output the transformed transcript data object to the client device.

20. The non-transitory computer-readable medium of claim 19, wherein the instructions further cause the apparatus to:
access external service rules and templates associated with an external service; and
generate transcript transformation prompts based on the external service rules and templates, wherein the transcript transformation model generates the transformed transcript data object based on the transcript transformation prompts.
